(19) United States
(12) Patent Application Publication
(10) Pub. No.: US 2007/0002044 A1
(43) Pub. Date: Jan. 4, 2007

(54) System and method for a compressed hierarachical stencil buffer

(76) Inventors: Adam Lake, Portland, OR (US); Dean Macri, Beaverton, OR (US)

Correspondence Address: Randolph P. Calhoune;INTEL CORP., Buckley, Maschoff & Talwalkar LLC, Five Elm Street, New Canaan, CT, 06840, US

(21) Appl. No.: 11/170,822

(22) Filed: Jun. 30, 2005

(51) Int. Cl. G06T 15/40

(52) U.S. Cl. 345/422

(57) ABSTRACT

A system and method to provide a hierarchical stencil buffer, the method including creating, for a light source of a graphics scene, a hierarchical stencil buffer (HSB) to store stencil values relative to the light source for a plurality of hierarchical levels of pixels, and storing the stencil values in the HSB in a compressed state. In some embodiments, a shadow test may be performed on a pixel to determine whether the pixel is in shadow relative to the light source, wherein the determining references a stored stencil value for a first hierarchical level in the HSB.

### BACKGROUND

There is a continuing demand for graphics applications that are faster, more realistic, and more detailed than previous graphics applications. Some such demanding graphics applications include, for example, video, mobile computing, gaming, educational, and personal computing applications. Accordingly, there is an accompanying demand and desire to process graphics data faster, with greater detail, and in general, more realistic and in real-time.

Realistic rendering or displaying of three-dimensional (3-D) graphics may be limited by in some instances due to constraints of a processing system and/or a methodology for rendering the 3-D graphics. 3-D graphics may be rendered using pipelined processing to provide different effects such as, for example, textures, Z-buffering, and color blending. However, the pipeline may be slowed, compromised, or impractical for providing realistic 3-D graphics in real-time due to inefficiencies therein.

Thus, there exists a need for a system and method to efficiently process 3-D graphics.

### BRIEF DESCRIPTION OF THE DRAWINGS

FIG. 1 is an exemplary representation of a process, in accordance with some embodiments herein;

FIG. 2 is an exemplary schematic and flow diagram, in accordance with some embodiments herein;

FIG. 3 is an exemplary schematic and flow diagram, in accordance with some embodiments herein;

FIG. 4 is an exemplary stencil buffer to compress, in accordance with some embodiments herein;

FIG. 5 is an exemplary flow diagram, in accordance with some embodiments herein;

FIG. 6 is an exemplary flow diagram, in accordance with some embodiments herein; and

FIG. 7 is a block diagram of a data processing system, including a graphics processor, in accordance with some embodiments herein.

### DETAILED DESCRIPTION

The several embodiments described herein are solely for the purpose of illustration. Embodiments may include any currently or hereafter-known versions of the elements described herein. Various embodiments of the present disclosure will be described in detail. However, such details are included to facilitate understanding of and to describe exemplary embodiments of the present disclosure. In some instances details such as, well-known methods, types of data, protocols, procedures, components, electrical structures and circuits, are not described in detail, or are shown in block diagram form, in order not to obscure embodiments hereof. Furthermore, some embodiments may be described in particular embodiments but may be implemented in hardware, software, firmware, middleware, or a combination thereof. Therefore, persons skilled in the art will recognize from this description that other embodiments may be practiced with various modifications and alterations.

Conventional stencil buffers provide a mask for a scene being rendered on a per-pixel basis. The per-pixel formation and processing of a conventional stencil buffer requires considerable bandwidth (e.g., bus traffic). High costs to system resources, including processing power consumption, processing time, heat generation, and memory allocations, may effectively compromise a graphics processing and rendering operation.

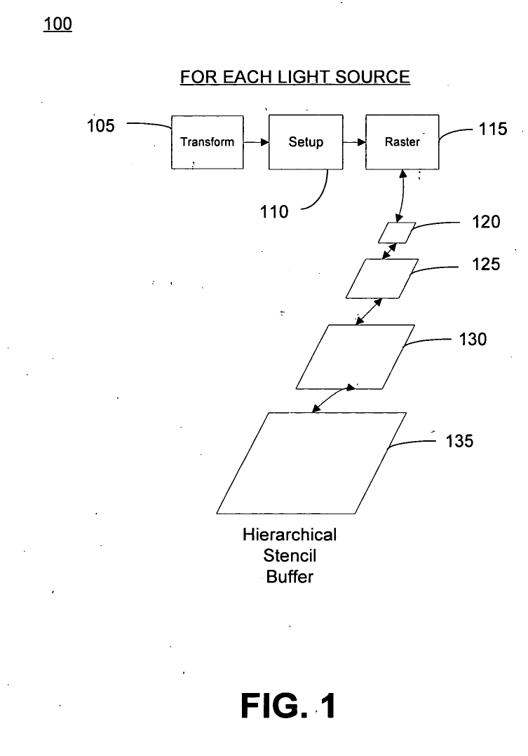

In some embodiments herein, a hierarchical stencil buffer (HSB) is provided to reduce bandwidth requirements for processing graphics. As an initial matter, the HSB is created to accommodate stencil values. FIG. 1 is an exemplary schematic diagram 100 for creating a HSB. At a first operation 105, graphics primitives may be transformed from the object coordinates of an object in a graphics scene to the frame of reference of a light in the scene. The transformation may be accomplished in any of a number of known methods and techniques for transforming object coordinates into a suitable frame of reference for processing and rendering by a graphics operation (e.g., pipeline, graphics engine, etc.) For example, a transformation engine may process the graphics primitives.

At operation 110, the graphics data is setup for processing by the graphics processing operation 100. Setup logic may take vertice information defining point locations (e.g., x, y, z coordinates) and translate the vertice information to data that may be used in further processing of the graphics. For example, setup operation 110 may include extruding an edge(s) of an object in the scene being rendered. Setup operation 110 may further include operations related to a light source as indicted in the legend of FIG. 1. Setup operation 110 may also include setup translations related to texture, depth, color, and other types of operations.

In some embodiments herein, as a graphics scene is rendered relative to a light source in the graphics scene, a HSB may be created to store stencil values. The stencil values may provide an indication of whether the pixels being rendered are illuminated by the light source in the scene or in shadow relative to the light source. In some embodiments, the HSB writes all pixels that are in shadow relative to the light source to the buffer thereof.

The format of the stencil value may vary or be based on implementation (i.e., format) of the HSB. In some embodiments, the format of the stencil buffer values may be based on a hardware and/or software protocol, or other factors. For example, some hardware and software implementations may use 8 bits for stencil values whereas other systems may use 1 bit. It should be appreciated that the format or protocol for representing the stencil values may vary, while adhering to other aspects of some embodiments herein.

FIG. 1 illustrates that the HSB includes a number of hierarchical levels of pixels 120, 125, 130, 135. Each hierarchical level represents a different sized tile. The particular size and number of hierarchical levels created or provided by graphics processing operation 100 may vary. The particular size and number of hierarchical levels created or provided may be based, for example, on available memory in a system or device that will implement embodiments herein. Other factors that may impact the particular size and number of hierarchical levels created or provided may include a desired resolution for a rendered scene, the capability of a display device to which the scene will be rendered, an application associated with graphics processing operation 100, and other influences that may impact the processing of graphics. In some embodiments, the size and number of hierarchical levels may be predetermined, and in some embodiments the size and number of hierarchical levels created or provided may be dynamically determined and provided. In some embodiments, the size of the hierarchical levels created or provided may vary from a full screen size (e.g., 640×480).

In some embodiments, the creation of the HSB as outlined in FIG. 1 may be done for each light source in a graphics scene. Prior to creating the HSB for each light source, the stencil buffer is cleared to a predetermined value.

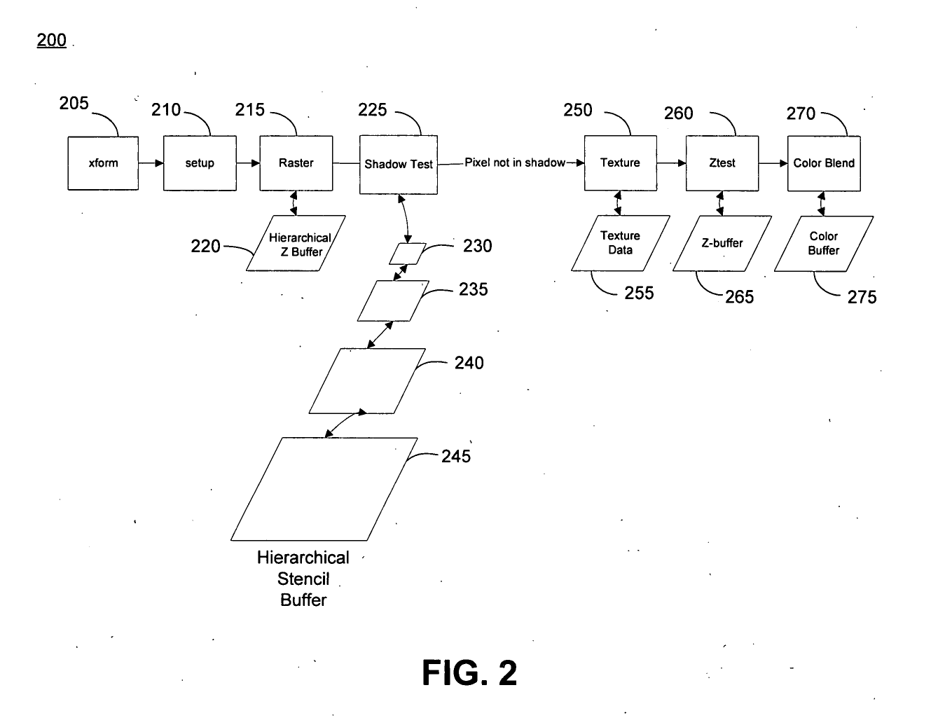

FIG. 2 is an exemplary schematic diagram of a graphics pipeline 200 using an HSB to benefit the graphics processing provided by the pipeline graphics operations. Transformation operation 205 and setup operation 210 may be similar to the transformation and setup operations discussed regarding FIG. 1. Moreover, transformation operation 205 and setup operation 210 may be performed in a manner consistent with those functions, as understood by those skilled in the art.

A rasterization operation 215 may render a graphics scene to determine Z (i.e., a depth) values for the objects, surfaces, and areas in the scene. As understood by those skilled in the art, the Z values are used to resolve visibility in the scene. A hierarchical Z buffer 220 may be used to depth values.

At operation 225, a shadow test is performed on the objects, surfaces, and areas in the graphics scene being processed. The shadow test operation 225 operates to avoid performing the shadow test on a per-pixel basis. Performing a shadow test for a graphics scene on a pixel-by-pixel basis may be extremely resource hungry and time consuming. Furthermore, the bandwidth that may be used to make the transfers of information between a processor and a memory, may impact other operations relying on the bus structure. In some embodiments, a reduction in the number of times a processor references a memory device may provide a corresponding reduction in power consumption and heat generation by the processor.

Shadow operation 225 includes, after the HSB is written to memory (e.g., a cache memory, a RAM device, etc.), testing pixels as they are rendered to see if they are in (out) shadow relative to a light source previously used to create the HSB. Since the HSB includes a number of hierarchical levels or representation of the graphics scene, shadow test operation 225 may not need to traverse the entire hierarchical stencil buffer to make a determination of whether a particular pixel is in shadow. For example, shadow test operation 225 may compare a pixel to a 32×32 pixel hierarchical level to see if it is in (out) shadow. If the pixel is in shadow, then there is no need to further traverse the HSB since lower resolution hierarchical levels (e.g., 16×16, 8×8, 4×4) including the pixel will also indicate that the pixel is in shadow. In this manner, a savings in processing power, processing time, and bandwidth utilization may be provided by the HSB, in some embodiments hereof.

In some embodiments, in the event shadow test operation 225 determines the tested pixel is in shadow, an “in shadow” value is associated with the pixel. The “in shadow” value may be passed down the pipeline to assist in other operations and/or provide a tag for the pixel. In some embodiments, some additional information may be passed down pipeline 200 even though the pixel failed shadow test operation 225. The additional information may include, for example, shadow penumbra or an alpha value (i.e., transparency) that may be used in, for example, a blending function to create soft shadows.

In the event shadow test operation 225 determines the tested pixel is not in shadow (i.e., visible), then the pixel is permitted to continue down pipeline 200 for further processing operations. The further processing operation may be used to add texture, color, and other attributes for rendering, for example, a photo-realistic scene.

Those skilled in the art should appreciate that texture operation 250, Z test operation 260, and color blend operation 270 may be implemented in a variety of methods and techniques, without departing from the disclosure and embodiments herein. Each of texture operation 250, Z test operation 260, and color blend operation 270 may be implemented consistent with known texture, Z test, and color blend operations for rendering of graphics. It is noted that texture operation 250, Z test operation 260, and color blend operation 270 may use, store, and reference associated texture data 255, Z-buffer 265, and color buffer 275, respectively.

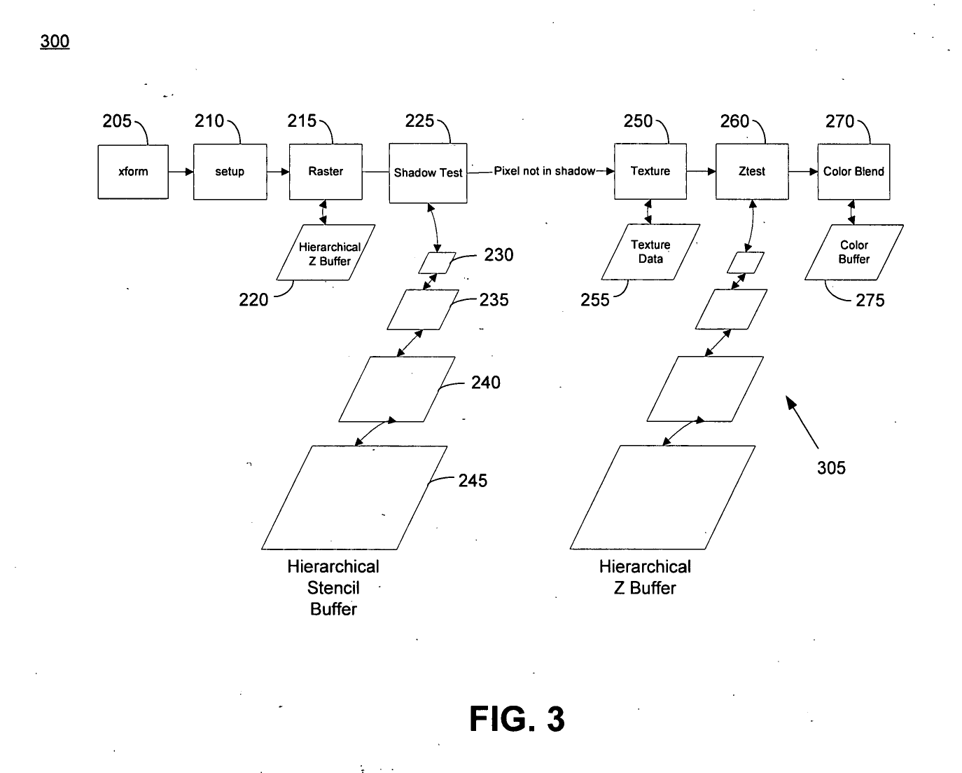

In some embodiments, Z test operation 260 may take advantage of operating efficiencies afforded by a hierarchical Z-buffer, as understood by those skilled in the art. FIG. 3 is a pipeline 300 wherein Z test operation 260 is modified to reference a hierarchical Z-buffer 305. It is noted that the data structure of hierarchical Z-buffer 305 is not related to or predicated on the data structure of the HSB herein.

Also, presented in FIGS. 2 and 3 is the aspect that the HSB herein may be implemented into a graphics processing pipeline without altering other graphics processing operations (e.g., texturing, Z testing, etc.). This aspect of some embodiments is illustrated by the HSB herein using (i.e., inputs) and providing (i.e., outputs) data structures that may be used in a graphics processing pipeline.

In some embodiments herein, the highest n levels of the HSB may be aligned with the size of cache (i.e., memory) available. It is noted that size of memory referenced here may be taken after subtracting out cache that may be needed for other purposes such as, for example, higher levels of hierarchical z, textures, etc. Also, due the reduced memory requirements that may be afforded by using the HSB in some embodiments herein, numerous stencil tests may be available in local cache, thereby resulting in a significant reduction in bandwidth over a bus.

In some embodiments herein, the HSB is compressed. That is, the values stored in the HSB are in a compressed state. In some embodiments, graphics rendering hardware may be modified to read the stencil value and do a decompression thereof. Also, sending compressed stencil values of the HSB across a computing system bus is another way to reduce memory bandwidth.

In some embodiments, the HSB may not contain a continuous set of hierarchical levels. While the HSB may contain a plurality of hierarchical levels, each one half the size of the one above it, in some embodiments some of the levels of the HSB herein may be eliminated. The elimination of certain HSB hierarchical levels may be based on an optimization of the HSB. Additionally, implementations of the HSB herein are flexible since the size of the HSB levels stored in hardware may vary.

The following is an exemplary outline of a shadow algorithm using a HSB and compression:

| 1. | For each frame compute: | |
|---|---|---|
| | a. | Render scene with only ambient lighting |
| | b. | For each light source: |

| | |
|---|---|
| i. | Clear stencil buffer, writing a 0 into all stencil locations |
| | (Where 0 = not in shadow) |
| ii. | Transform a scene to render the scene into stencil buffer |
| | from light source perspective |
| iii. | For each object: |

| | |
|---|---|
| 1. | Extrude the silhouette edge as seen by the light |
| | source away from the light source |
| 2. | Rasterize each face of the volume: |

| | |
|---|---|
| a. | If front-facing, for each pixel that fails the z- |
| | test, decrement the stencil buffer |
| b. | else (back-facing), for each pixel that fails |
| | the z-test, increment the stencil buffer |

| | |
|---|---|
| iv. | Construct hierarchical stencil buffer as follows: |

| | |
|---|---|
| 1. | Repeat for each level of the hierarchy: |

| | |
|---|---|
| a. | Loop over each group of N × M pixels and |
| | determine the smallest value (for this |
| | example usage, the values will either be 0 |
| | or 1. |
| b. | Store the max of this groups values in the |
| | next higher level of the hierarchy |

| | |
|---|---|
| v. | For eye point: |

| | |
|---|---|
| 1. | Transform to render scene into framebuffer from |
| | eye perspective |

| | |
|---|---|
| a. | For each object, scan convert: |

| | |
|---|---|
| i. | For each pixel that passes the z-test |
| | (e.g., using a hierarchical z-buffer) |
| | For each level of the stencil hierarchy |

| | |
|---|---|
| 1. | Lookup in stencil to verify its |
| | not in shadow |

| | |
|---|---|
| a. | if in shadow (stencil |
| | buffer is non-zero): |

Do nothing

| | |
|---|---|
| b. | Else descend to next |
| | level in the stencil |
| | hierarchy |

If you are at the

bottom level write to frame
buffer with lighting according
to the light source. (The
pixel is not in shadow)

As mentioned herein above, the HSB may be compressed to further leverage efficiencies of the HSB gained by, for example, reduced bandwidth requirements. Compression may be used to introduce better memory hierarchy utilization by the HSB hierarchy. In one instantiation hereof, a simple run-length encoding (RLE) scheme for compressing the levels of the HSB hierarchy may be used. Using the algorithm from above, the HSB hierarchy will contain integer (e.g., a byte) values that are either 0 or 1. An escape sequence (e.g., an all 1's byte) may be used to indicate that all 0's or 1's will be compressed. Thus, each byte can include a repeat count in 7 bits with the remaining bit indicating whether the value being repeated is a 0 or a 1. A count of 128 may be prohibited since that particular bit sequences may indicate transitions in and out of the “0's and 1's” only modes. When not in the “0's and 1's” only modes, a high bit may be used to indicate a repeat count followed by the byte to repeat (i.e., non-repeating individual bytes with the high bit set would become two bytes).

What follows is an exemplary coding scheme for compressing an HSB, in accordance with some embodiments herein. For example,

8BIT Mode Compression May be Represented by:

Byte 0xFF: Transition to mode with only zero or one values, i.e., 1 BIT mode (See below)
Bytes with 0x80 bit set: Repeat count=byte & 0x7f. Next byte indicates value to repeat
Bytes without 0x80 bit set Individual byte.
   1BIT Mode Compression May be Represented by:
Byte 0xFF: Transition back to 8BIT mode
Otherwise: Count=(Byte & 0xFE)>>1, value=Byte & 0x01. Repeat the value count times.

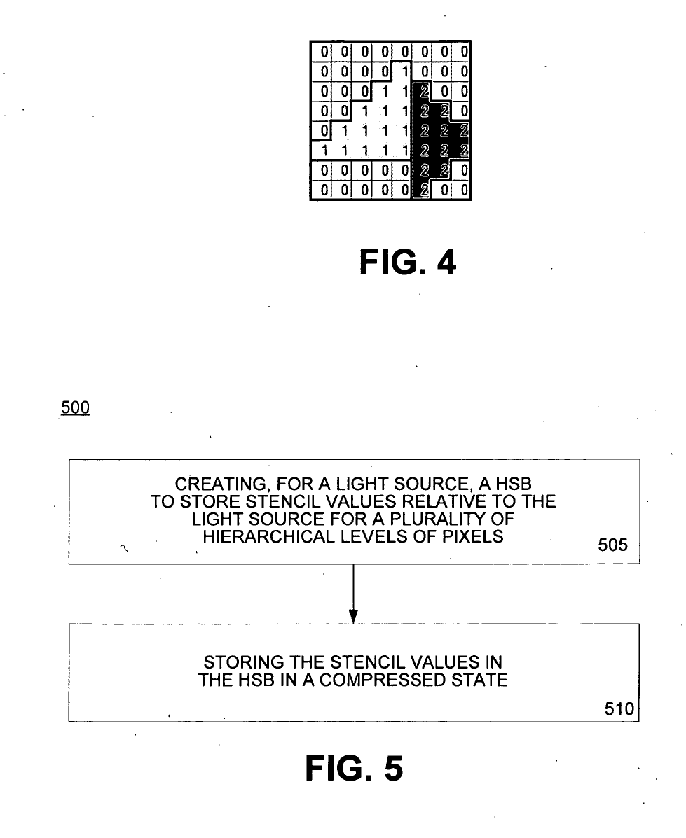

As an example, refer to the image of a sample stencil buffer section in FIG. 4. The sample image would be 64 bytes if uncompressed (assuming 1 byte per sample). Now, applying the above-disclosed algorithm, encoding is started at the repeating block of 12 zeros (i.e., starting at the upper left, progressing left to right into the 2^{nd} row). One encoding will be as two bytes: 0xFF, 0x18 (the 1^{st} byte escapes into “1BIT” mode and the second byte represents a count of 12 (0x18>>1=0x0C=12) of the value 0 (0x18& 1=0). Per the encoding in Table 1, the original 64 bytes may be compressed down to the following 32 bytes: FF 18 03 0C 07 FF 02 FF 08 07 FF 02 02 FF 06 09 FF 83 02 85 01 83 02 85 00 82 02 86 00 02 00 00.

TABLE 1

| | | | Mode | |
|---|---|---|---|---|
| Value | Repeat | Mode | Escape | Encoding |
| 0 | 12 | 1 BIT | 0xFF | 0x18 |
| 1 | 1 | 1 BIT | | 0x03 |
| 0 | 6 | 1 BIT | | 0x0C |
| 1 | 2 | 1 BIT | | 0x07 |
| 2 | 1 | 8 BIT | 0xFF | 0x02 |
| 0 | 4 | 1 BIT | 0xFF | 0x08 |
| 1 | 3 | 1 BIT | | 0x07 |
| 2 | 2 | 8 BIT | 0xFF | 0x02 0x02 |
| 0 | 2 | 1 BIT | 0xFF | 0x06 |
| 1 | 4 | 1 BIT | | 0x09 |
| 2 | 3 | 8 BIT | 0xFF | 0x83 0x02 |
| 1 | 5 | 8 BIT | | 0x85 0x01 |
| 2 | 3 | 8 BIT | | 0x83 0x02 |
| 0 | 5 | 8 BIT | | 0x85 0x00 |
| 2 | 2 | 8 BIT | | 0x82 0x02 |
| 0 | 6 | 8 BIT | | 0x86 0x00 |
| 2 | 1 | 8 BIT | | 0x02 |
| 2 | 0 | 8 BIT | | 0x00 0x00 |

In this illustrative but simple example, 2-bits per byte could have been used to compress everything down to 16 bytes. However, the example was provided as an illustration of a representative compression, not an exhaustive discussion. Furthermore, it should be appreciated that other compression techniques, methods and protocols may be used in conjunction with the HSB hereof. Other compression schemes may be beneficial depending on the types of data being encoded. For example, encoding may be conducted on a block basis (e.g. 16×16) to get better spatial coherency of the data. The deltas between adjacent values may be computed before compressing so that gradients (e.g. soft shadow falloffs) may be turned into constant values.

In an instance where the HSB contains only values of 1 or 0 as presented in the example here, a compression scheme that packs every 8 values into a byte may be used instead of other compression techniques, methods, and schemes. In some embodiments, the RLE compression scheme (or others) hereof may be done in conjunction with another scheme.

FIG. 5 is an illustrative flow diagram of a method 500, according to some embodiments herein. At operation 505, a HSB is created for a light source in a scene being rendered. The HSB is created to store stencil values for a plurality of hierarchical levels of pixels. The number and size of the hierarchical levels of pixels may vary. The variance may be due, in some embodiments, to an availability of memory to accommodate the HSB. The various hierarchical levels of pixels may also represent varying degrees of resolution regarding a scene.

At operation 510, stencil values are stored in the HSB in a compressed state. The compression scheme may vary. The HSB may include stencil values for all pixels not in shadow (or in shadow) relative too the light being evaluated.

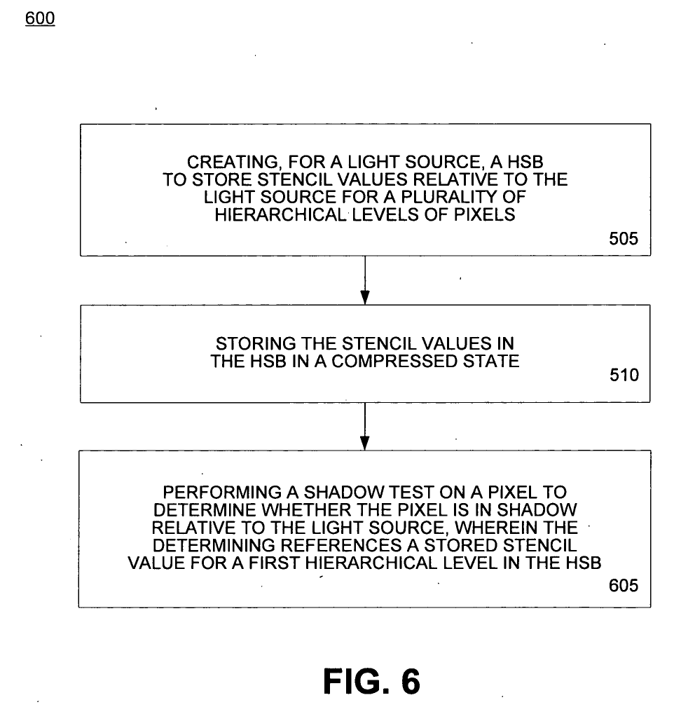

FIG. 6 is another exemplary flow diagram of a method 600, in accordance with some embodiments herein. FIG. 6 is similar to FIG. 5 but for an additional operation 605. Operation 605 includes the process of performing a shadow test on a pixel to determine if the pixel is in shadow relative to the light source, wherein the determining references a stored stencil value for a first hierarchical level in the HSB. Subsequent to operation 605 (not shown), further references may be made to the HSB and other hierarchical levels other than the first referenced first hierarchical level.

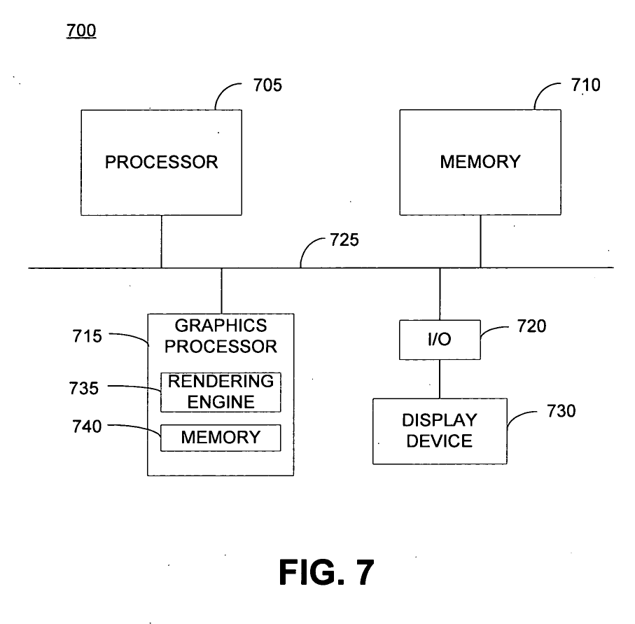

FIG. 7 is an exemplary block diagram of a system 700, in accordance with some embodiments herein to implement a system and apparatus of providing a HSB, including a compressed HSB. System 700 may include a computing device 750 such as, for example, desktop computer, a laptop computer, a mobile computing device such as a portable gaming platform/system, a personal digital assistant, a mobile communication device, and combinations thereof. Computing device 750 may include a processor 705 (e.g. a central processing unit (CPU) coupled to a memory 710, a graphics processor 715 and an input/output (I/O) interface 720, through bus 725. Memory 710 may be any type of memory, including but not limited to random access memory (RAM), dynamic RAM (DRAM), double data rate memory, a hard drive, a storage device operable with a removable storage medium. Memory 710 may store an operating system, applications, programs, and other instructions to implement various aspects of some embodiments herein, including computer-executed instructions.

In some embodiments, one of a number of devices that may be connected to I/O interface 720 includes a display device 730. Display device 730 may provide a mechanism upon which graphics may be rendered.

Graphics processor 715 may be utilized to perform graphics processing for the processor 705 in order to reduce the workload on processor 705. Moreover, graphics processor 715 may include a rendering engine 735 having a rendering pipeline in accordance with embodiments hereof for a HSB, including a compressed HSB. In some embodiments, graphics processor may not be present or may not be used in a creation and/or usage of a HSB herein. In some embodiments processor 705 may be used, alone or in combination with other devices (e.g., memory 710) to implement some of the embodiments herein.

It should be appreciated that system 700 is only exemplary and that any type of computing device that renders graphics may be utilized in implementing aspects of the invention. In some embodiments,

It should be understood that system 700 may include, in some embodiments, additional, fewer, and alternative components and devices to those depicted in FIG. 7, in accordance with some embodiments herein.

The following table, Table 2, illustrates a bandwidth reduction that may be obtained using a HSB, in accordance herewith. If it is assumed that that the HSB has a capture rate of 50%, then the bandwidth may be reduced from about 2 GB/s to about 1 GB/s. In the instance a 90% capture rate is assumed, the table shows that only about 2 MB/s bandwidth is required.

TABLE 2
Bandwidth Reduction using HSB

| | Average | | | |
|---|---|---|---|---|
| Hierarchical | Number | Bytes per | Total | |
| Stencil Buffer | Ops | op | Bytes/Op | |
| Texture Read | 4 | 4 | 16 | |
| Texture Write | 0 | 4 | 0 | |
| Z Reads | 4 | 4 | 16 | assume float = 4 bytes |
| (assume N | | | | |
| levels of | | | | |
| overdraw) | | | | |
| Z Writes | 3 | 4 | 12 | assume float = 4 bytes |
| | | | | alpha writes on a few |
| Color Reads | 0 | 4 | 0 | pixels . . . rounds to 0 |
| Color Writes | 1 | 4 | 4 | |
| Stencil Reads | 4 | 1 | 4 | assume short int = 8 bits |
| Stencil Writes | 3 | 1 | 3 | assume short int = 8 bits |
| | | Total | 55 | |
| | | Bytes/ | | |
| | | Op | | |
| | Width | height | | |
| Framebuffer | 1280 | 1024 | 1,310,720 | |
| Size | | | | |
| Bandwidth | | | 72,089,600 | 70 MB/frame |
| Per Frame | | | | |
| Frames Per | | | 30 | |
| Second | | | | |
| Total | | | 2,162,688,000 | 2 GB/s |
| Bandwidth | | | | |
| Consumed | | | | |
| Hierarchical | | | 1,081,344,000 | ˜1 GB/s, assume 50% intercept |
| Stencil Buffer | | | 216,268,800 | ˜2 MB/s, assume 90% intercept |

Estimates based on our calculations are 50-90% bandwidth reduction per light source. The bandwidth was calculated in the table above, and the 50-90% savings is based on the bandwidth savings obtained using a hierarchical technique for the z-buffer.

The foregoing disclosure has been described with reference to specific exemplary embodiments thereof. It will, however, be evident that various modifications and changes may be made thereto without departing from the broader spirit and scope set forth in the appended claims.

1. A method comprising:
creating, for a light source, a hierarchical stencil buffer (HSB) to store stencil values relative to the light source for a plurality of hierarchical levels of pixels; and
storing the stencil values in a compressed state.

2. The method of claim 1, further comprising performing a shadow test on a pixel to determine whether the pixel is in shadow relative to the light source, wherein the determining references a stored stencil value for a first hierarchical level in the HSB.

3. The method of claim 2, further comprising descending to a next hierarchical level and performing the shadow test at each successive hierarchical layer until the pixel fails the shadow test or a bottom hierarchical level is reached; and
providing the pixel for rendering.

4. The method of claim 2, further comprising providing an indication that the pixel failed the shadow test.

5. The method of claim 1, further comprising clearing all values of the HSB to a predetermined value prior to processing of another light source for the HSB.

6. The method of claim 1, further comprising:
performing a Z test on a pixel to determine whether the pixel is visible; and
for passing the Z test, providing the pixel for rendering.

7. The method of claim 1, wherein a size of the HSB is based on an available memory for use by the HSB.

8. A computer-readable medium having computer-executable instructions stored thereon for use in graphics rendering, which when executed cause the computer to perform a method comprising:
creating, for a light source, a hierarchical stencil buffer (HSB) to store stencil values relative to the light source for a plurality of hierarchical levels of pixels; and
storing the stencil values in a compressed state.

9. The computer-readable medium of claim 8, further comprising performing a shadow test on a pixel to determine whether the pixel is in shadow relative to the light source, wherein the determining references a stored stencil value for a first hierarchical level in the HSB.

10. The computer-readable medium of claim 9, further comprising:
instructions for descending to a next hierarchical level and performing the shadow test at each successive hierarchical layer until the pixel fails the shadow test or a bottom hierarchical level is reached; and
instructions for providing the pixel for rendering.

11. The computer-readable medium of claim 9, further comprising instructions for providing an indication that the pixel failed the shadow test.

12. The computer-readable medium of claim 8, further comprising instructions for clearing all values of the HSB to a predetermined value prior to processing of another light source for the HSB.

13. The computer-readable medium of claim 8, further comprising instructions for:
performing a Z test on a pixel to determine whether the pixels is visible; and
passing the Z test, providing the pixel for rendering.

14. The computer-readable medium of claim 8, wherein a size of the HSB is based on an available memory for use by the HSB.

15. A processor to execute a computer program comprising the operation of:
creating, for a light source, a hierarchical stencil buffer (HSB) to store stencil values relative to the light source for a plurality of hierarchical levels of pixels; and
storing the stencil values in a compressed state.

16. The processor of claim 15, further comprising an operation of performing a shadow test on a pixel to determine whether the pixel is in shadow relative to the light source, wherein the determining references a stored stencil value for a first hierarchical level in the HSB.

17. The processor of claim 16, further comprising an operation of descending to a next hierarchical level and performing the shadow test at each successive hierarchical layer until the pixel fails the shadow test or a bottom hierarchical level is reached; and
providing the pixel for rendering.

18. The processor of claim 16, further comprising an operation of providing an indication that the pixel failed the shadow test.

19. The processor of claim 15, further comprising an operation of clearing all values of the HSB to a predetermined value prior to processing of another light source for the HSB.

20. The processor of claim 15, further comprising an operation of:
performing a Z test on a pixel to determine whether the pixel is visible; and
for passing the Z test, providing the pixel for rendering.

21. A system comprising:
a double data rate memory;
a processor connected to the memory and operative to:
creating, for a light source, a hierarchical stencil buffer (HSB) to store stencil values relative to the light source for a plurality of hierarchical levels of pixels; and
storing the stencil values in a compressed state.

22. The system of claim 21, further comprising performing a shadow test on a pixel to determine whether the pixel is in shadow relative to the light source, wherein the determining references a stored stencil value for a first hierarchical level in the HSB.

23. The system of claim 22, further comprising:
descending to a next hierarchical level and performing the shadow test at each successive hierarchical layer until the pixel fails the shadow test or a bottom hierarchical level is reached; and
providing the pixel for rendering.

24. The system of claim 21, further comprising:
performing a Z test on a pixel to determine whether the pixels is visible; and
for passing the Z test, providing the pixel for rendering.
